(19) United States
(12) Patent Application Publication
(10) Pub. No.: US 2004/0012227 A1
(43) Pub. Date: Jan. 22, 2004

(54) Vehicle frame part

(76) Inventor: Adrian Robinson, Ballymena (GB)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/240,497

(22) PCT Filed: Apr. 4, 2001
(86) PCT No.: PCT/GB01/01464

(30) Foreign Application Priority Data
Apr. 4, 2000 (GB) 0008076.2

(51) Int. Cl. B62D 25/00

(52) U.S. Cl. 296/178

(57) ABSTRACT

An extruded vehicle frame part having one or more channels along its length which face inwardly into the vehicle in use, and for connection of interior finishing pieces thereto is described. The frame parts are preferably aluminium or plastic, and the vehicle can be a bus. The present invention provides a simple method of conjoining the interior finishing pieces of a vehicle such as a bus to the frame structure. The present invention obviates the need for additional bolts or glue which traditional fitting require. The present invention also avoids the need for holes or apertures be created in the frame parts to receive e.g. bolts.

This invention relates to a vehicle frame part adapted to receive interior finishing pieces or panels, particularly but not exclusively for use with passenger service vehicles such as buses.

Once the frame structure of a passenger service vehicle such as a bus is formed, the interior finishing pieces or panelling are attached to the frame pieces; the interior finishing pieces are the pieces of interior cladding and panelling seen by the passenger.

Naturally, it is desired for the finishing pieces and panels to appear to fit seamlessly on and around the frame pieces, but be securely attached thereto. Presently, such finishing pieces can be bolted onto frame parts. The bolting is conducted by drilling holes into the frame parts through which the bolts are fitted.

It is an object of the present invention to provide vehicle frame parts already adapted to receive finishing pieces and panels.

Thus, according to one aspect of the present invention, there is provided an extruded vehicle frame part having one or more channels along its length which face inwardly into the vehicle in use, and for connection of interior finishing pieces thereto.

The channels can have any suitable shape, size or design able to fit with interior finishing or trim pieces either directly or indirectly, i.e. via connecting or other fastening fittings or pieces such as screws, bolts, toggles, etc. Other faces of the vehicle frame parts could also have channels therein for connection with other parts of the vehicle, including interior finishing pieces.

The interior finishing pieces include interior trims, panels, cappings, covings, etc., as are known in the art.

The vehicle frame part must still be able to provide relevant support to the vehicle. Such frame parts are therefore preferably metal such as aluminium, or strong plastic.

The finishing pieces can have a complementary mating means to provide direct conjunction with the channels of the vehicle frame parts. The conjunction of the finishing pieces and the channels of the frame parts may be based on a male-female locking interconnection.

According to one embodiment of the present invention, the top of one or both side walls of one or more of the channels of the vehicle frame part have inwardly facing flanges. Preferably the lower edges of such flanges form an acute angle with the inner edge of their side walls, so as to provide hook-like edging on one or both sides. This assists the interconnection with complimentary-shaped finishing or connection pieces such as nuts.

Preferably, the finishing pieces and the vehicle frame parts are separable whenever desired or necessary, e.g. for refurbishment or repair of the vehicle interior.

It is recognised that aluminium extrusions having particular configurations of open channels are known from e.g. GB 1334050 or U.S. Pat. No. 5,934,739. However, such extrusions have not been used or suggested as suitable for fitting interior pieces in modern passenger service vehicles.

The present invention could be provided in the form of a frame and finishing kit comprising a set of extruded vehicle frame parts as hereinbefore described, and a set of interior finishing pieces having complimentary mating means to provide conjunction with the channels of the vehicle frame parts.

Embodiments of the present invention will now be described by way of example only and with reference to the accompanying diagrammatic drawings in which;

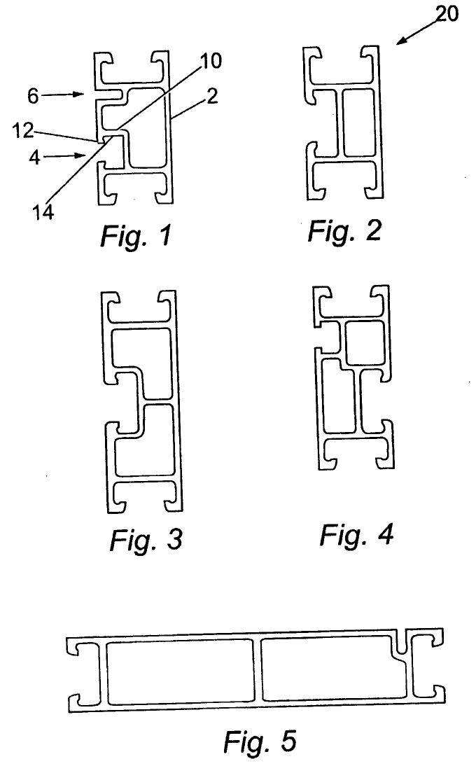

FIGS. 1-5 which are cross-sectional views of various vehicle frame parts according to the present invention;

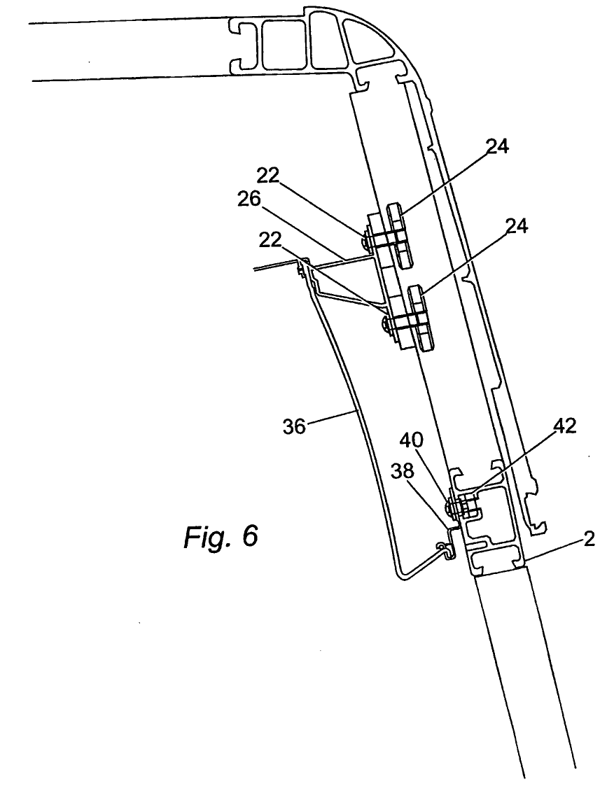

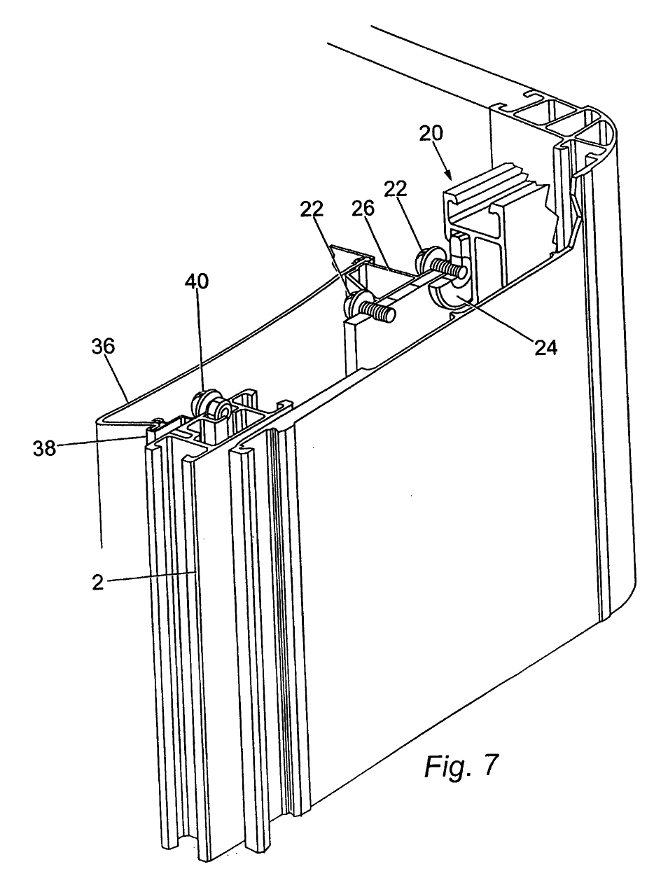

FIGS. 6 and 7 are side and perspective cross-sectional views of the vehicle frame part in FIG. 1 with interior roof coving.

Referring to the drawings, FIGS. 1-5 show five different extruded vehicle frame parts for use in the construction of the frame of a passenger service vehicle such as a bus. Different sections of the bus require different vehicle frame parts, but each vehicle frame part shown has one or two inwardly facing channels.

Looking at FIG. 1 as a representative example, the frame part 2 has first and second channels 4, 6 able to receive an interior finishing piece. FIG. 1 also shows the top of each side wall 10 of one of the channels 4 having inwardly facing flanges 12, the lower edges of which form an acute angle with inner edge of each side wall 14. This provides a hook-like edging along the length of the extrusion part 2.

FIGS. 6 and 7 show the use of the frame part 2 in FIG. 1 in a vehicle frame, that is above a window position. There, the first channel 4 is used to support the base of a roof coving piece 36, via support piece 38 and screw 40 and toggle-nut 42. Because of the invention, the screw 40 can be fitted anywhere along the length of the frame part 2, making interior pieces easier to fit. The shape of the nut 42 is complimentary to the hook-like edging of the channel 4, to provide secure inter-engagement once fastened.

FIGS. 6 and 7 also show the use of the frame part 20 in FIG. 2, for securing the screws 22 and nuts 24 in the same manner for an upper support section 26 also holding the cove piece 36.

The present invention provides a simple method of conjoining the interior finishing pieces of a vehicle such as a bus to the frame structure. The present invention obviates the need for additional bolts or glue which traditional fitting require. The present invention also avoids the need for holes or apertures to be created in the frame parts to receive e.g. bolts.

1. An extruded vehicle frame part having one or more channels along its length which face inwardly into the vehicle in use, and for connection of interior finishing pieces thereto.

2. A frame part as claimed in claim 1 wherein the part is aluminium or plastic.

3. A frame part as claimed in any one of the preceding claims wherein a finishing piece has a complementary mating means to provide conjunction with a channel of the vehicle frame part, and the conjunction of the finishing piece and the channel is based on a male-female locking interconnection.

4. A frame part as claimed in any one of the preceding claims wherein the top of one or both side walls of a channel of the vehicle frame part has inwardly facing flanges.

5. A frame part as claimed in claim 4 wherein the lower edges of the flanges form an acute angle with the inner edge of their side walls, so as to provide hook-like edging on one or both sides.

6. A frame part as claimed in any one of the preceding claims wherein the finishing pieces and the vehicle frame parts are separable.

7. A frame part as claimed in any one of the preceding claims wherein one or more of the channels are “C” shaped.

8. A frame part as claimed in any one of the preceding claims wherein an interior piece is fittable directly to one or more channels of the frame part.

9. A frame part as claimed in any one of claims 1-7 wherein an interior piece is fittable to one or more channels of the frame Part via one or more intermediate connection, fastening or fitting means.

10. A frame part as claimed in any one of the preceding claims wherein an interior piece is fitted to a frame part using a screw and toggle-nut, the toggle-nut being in the channel.

11. A frame part as claimed in any one of the preceding claims wherein the vehicle is a bus.

12. A frame part substantially as hereinbefore described and with reference to the accompanying drawings.
